(19) United States
(12) Patent Application Publication
(10) Pub. No.: US 2025/0020896 A1
(43) Pub. Date: Jan. 16, 2025

(54) IMAGE PICKUP APPARATUS, OPTICAL SYSTEM, AND DETECTION SYSTEM

(71) Applicant: CANON KABUSHIKI KAISHA, Tokyo (JP)

(72) Inventor: Yuma KOBAYASHI, Tochigi (JP)

(21) Appl. No.: 18/766,807

(22) Filed: Jul. 9, 2024

(30) Foreign Application Priority Data
Jul. 10, 2023 (JP) 2023-112893

(51) Int. Cl. G02B 13/00; G02B 1/04; G02B 9/18

(52) U.S. Cl. CPC G02B 13/0085; G02B 1/041; G02B 9/18; G02B 13/0035

(57) ABSTRACT

An image pickup apparatus includes an optical system including a first substrate and a first optical element having refractive power disposed on the first substrate, and a light receiving element having a light receiving surface on which an image is formed by the optical system. A predetermined inequality is satisfied.

### BACKGROUND

### Technical Field

One of the aspects of the embodiments relates to an image pickup apparatus, an optical system, and a detection system.

### Description of Related Art

A compact optical system having high optical performance has conventionally been proposed for use in an image pickup apparatus that performs line of sight (visual line) detection, iris authentication, living body detection, etc. (see U.S. Pat. No. 9,798,115).

The conventional image pickup apparatuses may cause distortion and partial blurs in an image in a case where an object and the optical system do not directly face each other (or in a case where an object plane and a plane orthogonal to the optical axis are not parallel to each other). An image pickup apparatus has also been proposed that detects a line of sight by incorporating a half-mirror into an eyepiece optical system so that the object and the optical system directly face each other, but the half-mirror occupy a large space and the size of the image pickup apparatus increases.

### SUMMARY

An image pickup apparatus according to one aspect of the disclosure includes an optical system including a first substrate and a first optical element having refractive power disposed on the first substrate, and a light receiving element having a light receiving surface on which an image is formed by the optical system. The following inequality is satisfied:

0.2≤s/Rimmax≤1.1

where s is a distance from an intersection of an optical axis of the optical system and the light receiving surface to a center of the light receiving surface, and Rimmax is a distance from a farthest position from the center of the light receiving surface to the center. A detection system having the above image pickup apparatus also constitutes another aspect of the disclosure. An optical system according to another aspect of the disclosure includes a first substrate, a first optical element having refractive power disposed on the first substrate, and an optical element having a plane that contacts air. The following inequality is satisfied:

0.5≤θ≤20.0

where θ is an angle [°] of the plane relative to an optical axis in a section having the optical axis.

Further features of various embodiments of the disclosure will become apparent from the following description of embodiments with reference to the attached drawings.

### BRIEF DESCRIPTION OF THE DRAWINGS

FIG. 1 is a sectional view of an optical system according to Example 1.

FIG. 2 is an aberration diagram of the optical system according to Example 1.

FIG. 3 is a sectional view of an optical system according to Example 2.

FIG. 4 is an aberration diagram of the optical system according to Example 2.

FIG. 5 is a sectional view of an optical system according to Example 3.

FIG. 6 is an aberration diagram of the optical system according to Example 3.

FIG. 7 is a sectional view of an optical system according to Example 4.

FIG. 8 is an aberration diagram of the optical system according to Example 4.

FIG. 9 is a sectional view of an optical system according to Example 5.

FIG. 10 is an aberration diagram of the optical system according to Example 5.

FIG. 11 illustrates a light receiving surface of an image pickup apparatus according to Example 1 viewed from a direction orthogonal to an optical axis.

FIG. 12 illustrates a light receiving surface of an image pickup apparatus according to Example 2 viewed from a direction orthogonal to an optical axis.

FIG. 13 illustrates a light receiving surface of an image pickup apparatus according to Example 3 viewed from a direction orthogonal to an optical axis.

FIG. 14 illustrates a light receiving surface of an image pickup apparatus according to Example 4 viewed from a direction orthogonal to an optical axis.

FIG. 15 illustrates a light receiving surface of an image pickup apparatus according to Example 5 viewed from a direction orthogonal to an optical axis.

FIGS. 16A and 16B are schematic diagrams of an electronic apparatus according to Example 6.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

An image pickup apparatus according to each example includes an optical system (imaging optical system) IO and a light receiving element having a light receiving surface on which an image is formed by the optical system IO.

The optical system IO according to each example is a small optical system obtained using a technology called wafer level optics. Such an optical system is called a wafer level lens, and an image pickup apparatus that uses a wafer level lens as an imaging optical system is called a wafer level camera. The optical system IO according to each example is used as an imaging optical system used in a built-in camera of electronic apparatuses such as a mobile phone, a smartphone, a wearable terminal, and a head mount display (HMD), or as an objective optical system of an endoscope. The optical system IO according to each example may be used together with a main optical system such as an eyepiece optical system of the electronic apparatus described above, and may be used in a state where the optical system cannot directly face the object.

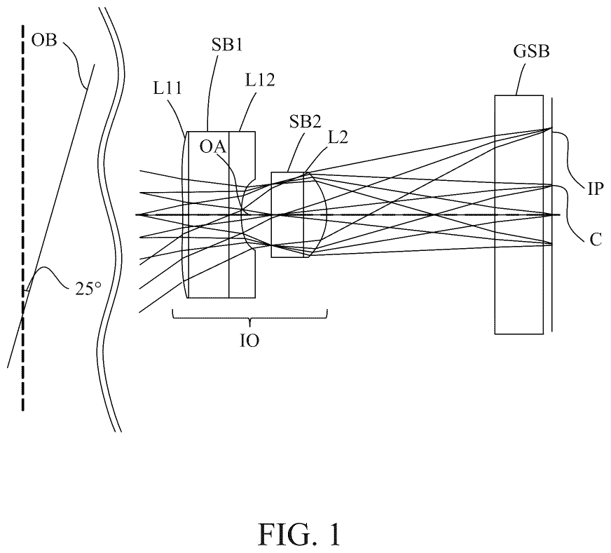

FIGS. 1, 3, 5, 7, and 9 are sectional views of the optical systems (wafer level lens/wafer level optics (WLO)) IO according to Examples 1 to 5, respectively. In each sectional view, a left side is an object side (front) and a right side is an image side (back).

OB represents an object plane. IP represents an image plane. An imaging surface of an image sensor such as a Charge Coupled Device (CCD) sensor or a Complementary Metal Oxide Semiconductor (CMOS) sensor in an image pickup apparatus may be disposed on the image plane IP. A photosensitive surface corresponding to a film surface of a film-based camera may be disposed on the image plane IP. However, as long as a light beam enters the effective area of the light receiving element such as an image sensor or a photosensitive element, the light beam does not need to enter the entire surface of the image plane IP.

The optical system IO according to each example includes a substrate (first substrate) and an optical element (first optical element) having refractive power disposed on the substrate. The optical system IO according to each example may include a substrate (first substrate) SB1 and a substrate (second substrate) SB2 arranged in order from the object side to the image side. In other words, the substrate SB2 may be disposed adjacent to the image side of the substrate SB1. An optical element (second optical element) having positive refractive power may be disposed on the image side of the substrate SB2. A glass substrate GSB for protecting the light receiving surface is disposed between the substrate SB2 and the image plane IP. However, a back cover glass may be used instead of the glass substrate GSB.

The glass substrate GSB may be one made by bonding two flat plates together. Thereby, the image pickup apparatus can be efficiently manufactured using a method for separately manufacturing the optical system and the imaging unit and for joining together the glass flat plates. The relative positions of the optical system and the imaging unit can be changed, and image pickup apparatuses with various specifications can be easily prepared.

In each example, each lens is manufactured by a wafer level process in order to reduce the size of the optical system IO. That is, they are manufactured by forming a lens layer made of a curable resin material or the like on a wafer that becomes the substrates SB1 and SB2. A large number of wafer-level lenses can be manufactured at once by disposing a substrate manufactured by a wafer-level process and a light receiving element at a predetermined distance, adhering them outside the effective area, and then cutting them.

Thermoplastic resin, ultraviolet curing resin, and thermosetting resin are used as materials for forming the lens layer. Examples include acrylic resins, modified acrylic resins, polycarbonate resins, modified polycarbonate resins (those containing a fluorene skeleton, Iupizeta manufactured by Mitsubishi Gas Chemical Co., Ltd., etc.), silicone resins, cycloolefin polymers, and cycloolefin copolymers, polyvinylcarbazole, polystyrene, polyethylene, Teflon, Teflon AF manufactured by Mitsui Chemours Fluoro Products Co., Ltd., Cytop manufactured by AGC Corporation, and perfluoroalkoxyalkanes. A blend, a copolymerization of some of them, or a further blend of the copolymerization may be used. Materials obtained by adding and/or kneading particles, crystals, etc. of organic low molecules or inorganic materials to these resin materials may also be used. Using such a resin material can easily form an optical element having a refractive index. The optical system IO according to each example may use glass, quartz, inorganic crystal, transparent ceramic, and engineering plastic as the substrate material. In each example, the substrates SB1 and SB2 are made of glass, but this example is not limited to this implementation.

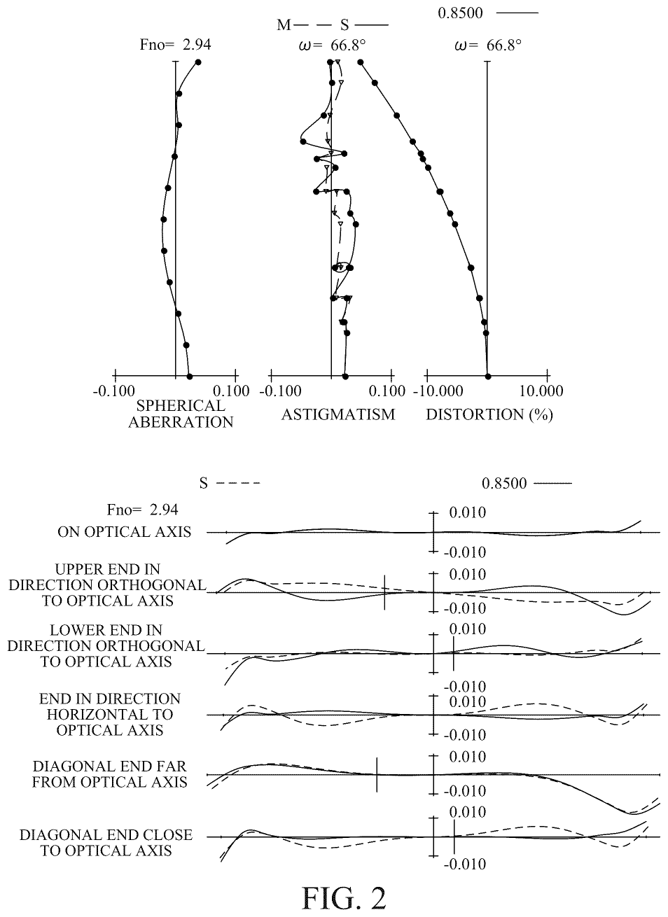

FIGS. 2, 4, 6, 8, and 10 are aberration diagrams of the optical systems IO according to Examples 1 to 5, respectively. Each aberration diagram includes a spherical aberration diagram, an astigmatism diagram, a distortion diagram, and a lateral aberration diagram. In the spherical aberration diagram, Fno represents an F-number. The spherical aberration diagram illustrates a spherical aberration amount for a wavelength of 850 nm or 950 nm. In the astigmatism diagram, S represents an astigmatism amount on a sagittal image plane, and M indicates an astigmatism amount on a meridional image surface. The distortion diagram illustrates a distortion amount for a wavelength of 850 nm or 950 nm. For astigmatism and distortion, a direction horizontal to the optical axis OA, a direction orthogonal to the optical axis OA, and a diagonal direction of the light receiving element are plotted in order of image height on the light receiving element, and spline interpolation is used between them. In the lateral aberration diagram, a solid line illustrates meridional lateral aberration, and a broken line illustrates sagittal lateral aberration. ω is the imaging half angle of view (°). The optical axis OA is defined as a rotation axis in a case where the optical system IO consists of a single lens having refractive power. In a case where the optical system IO includes two or more lenses, the optical axis OA is defined as a direction of the sum of the unit vectors in the direction of their rotational axes (both are defined as a direction from the object side to the image side).

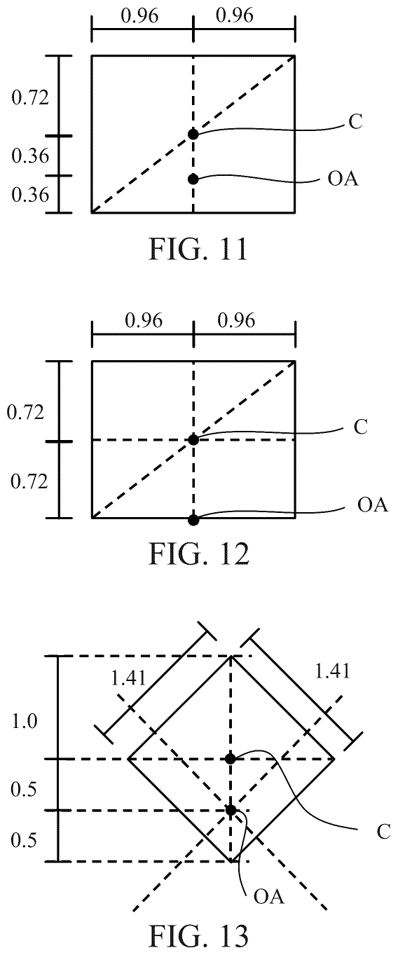

FIGS. 11, 12, 13, 14, and 15 illustrate the light receiving surfaces of the image pickup apparatuses according to Examples 1 to 5, respectively, viewed from a direction orthogonal to the optical axis OA. In each example, the optical system IO is disposed so that the optical axis OA does not coincide with the center C of the light receiving surface. That is, the optical axis OA of the optical system IO is tilted relative to the optical axis of the main optical system where the optical axis and the center of the light receiving surface coincide with each other on the light receiving surface. On the light receiving surface, the center of the effective area that contributes to imaging and image acquisition does not coincide with the center C of the light receiving surface.

A description will now be given of a characteristic configuration of the optical system IO according to each example.

The optical system IO according to each example satisfies the following inequality (1):

$$0.2 \leq s / Rimmax \leq 1.1 \qquad ( 1 )$$

where s is a distance from an intersection of the optical axis OA and the light receiving surface to the center C of the light receiving surface, and Rimmax is a distance from the farthest position from the center C of the light receiving surface to the center C.

For example, in a case where the light receiving surface has a rectangular or square shape, the distance Rimmax is a distance from the center C of the light receiving surface to the vertex. The center C of the light receiving surface and the position farthest from the center C of the light receiving surface are considered within the effective area that contributes to imaging of the light receiving surface. There is no restriction on the direction from the optical axis OA to the position of the center C of the light receiving surface, and the direction may be, for example, a long side direction, a short side direction, or a diagonal direction of the light receiving surface.

In a general coaxial optical system, the optical system and the object cannot face each other directly, keystone distortion and unilateral blur occur in a diagonal upward or downward view, for example. Separating the center C of the light receiving surface and the optical axis OA within the range of inequality (1) can offset the center of the imaging range from the optical axis OA. This configuration can provide an image pickup apparatus suitable for line-of-sight detection of a camera viewfinder or HMD, or living body detection of a wearable device, in which the optical system IO cannot directly face the object. For example, it is difficult to make the camera for line of sight detection face the object (user's eye and light reflected on the eye) because the eyepiece optical system is disposed at a position facing the user's eye in an eyepiece unit of a camera viewfinder or HMD. The optical system IO according to each example may be used under such circumstances.

In a case where the value becomes lower than the lower limit of inequality (1), the offset of the imaging range due to separating the center C of the light receiving surface and the optical axis OA reduces, and in an attempt to obtain high image quality, the optical system IO and the object are to almost directly face each other. In a case where the value becomes higher than the upper limit of inequality (1), a distance between the optical system IO and the light receiving element increases, and thereby the size of the image pickup apparatus increases, which is unsuitable for a strong need for miniaturization in HMDs and wearable devices.

Usually, in using a CMOS sensor or a CCD sensor, space is required for disposing wiring and circuits, and the size of the image pickup apparatus may increase. In the image pickup apparatus according to each example, the wiring and circuits of the light receiving element can be disposed on the side opposite to the center C of the light receiving surface using the optical axis OA as a reference. Therefore, wiring and circuits can be placed in the shadow of the lens, and size of the image pickup apparatus can be reduced.

Inequality (1) may be replaced with inequality (1a) below:

$$0.2 \leq s / Rimmax \leq 0.9 \qquad ( 1 a )$$

Inequality (1) may be replaced with inequality (1b) below:

$$0.2 \leq s / Rimmax \leq 0.7 \qquad ( 1 b )$$

The above configuration can realize an image pickup apparatus having a reduced size, and includes an optical system that has high optical performance even if the optical system does not directly face the object.

A description will now be given of configurations that may be satisfied in the optical system IO according to each example.

A lens (first optical element) L12 having negative refractive power may be formed on the image side of the substrate SB1, and a lens (second optical element) L2 having positive refractive power may be formed on the image side of the substrate SB2. These lenses are formed by the wafer level process. In such a configuration, imaging performance can be secured over a wide angle of view and the incident angle on the light receiving surface can be relaxed. These lenses may be aspheric lenses.

An aspherical lens (third optical element) L11 having positive refractive power at the end of an effective area that contributes to imaging may be formed on the object side of the substrate SB1. Off-axis aberrations can be satisfactorily corrected by disposing the aspherical surface at a position where the separation of on-axis and off-axis light rays is large. The positive refractive power at the end can create a nearly concentric surface for rays passing through the end, and the image quality at the end of the image can be improved. In the optical system IO according to each example, since the optical axis OA does not coincide with the center C of the light receiving element, a wider angle of view on one side is required than that of an optical system in which the optical axis coincides with the center of the light receiving element. Therefore, correction of off-axis aberrations is more important than that for a general optical system.

The substrate does not necessarily need to consist of a single substrate, and may include two or more substrates. In particular, in a case where the substrate SB1 includes two substrates, the optical performance can be improved by forming the lenses L11 and L12 on different substrates and pasting these two substrates together.

For the purpose of protecting the lens, a flat plate or a protective plate whose curvatures on both sides are approximately the same may be disposed on the object side. The flat plate or protection plate may be replaced with a wavelength selective filter, or the wavelength selection filter may be formed on a substrate.

A configuration in which the lens is formed closest to the object may use a resin material for the lens, and thus in a case where the lens is used while the lens is exposed to the outside world, surface durability may be an issue. However, in consumer products such as HMDs, it is common to use a cover member to secure appearance quality, so the problem caused by disposing the lens closest to the object is not necessarily significant.

An aperture stop (diaphragm) may be formed on the substrate SB2. The aperture stop can be formed on the substrate SB2 by, for example, depositing a light shielding film of chromium or the like using a mask, and then etching it after the deposition. Generally, an aperture stop refers to a diaphragm whose diameter is variable, but in this specification, it also includes a diaphragm whose diameter is not variable. The aperture stop may include a thin sheet having an aperture shape. The aperture shape is not limited to a circle, but may be a quadrilateral, a rounded quadrilateral with four fan-shaped corners, or the like. Forming the aperture stop on the substrate SB, that is, on a flat surface (plane), is suitable because it can facilitate control of the mask arrangement in the thickness direction.

Each of the lenses L12 and L2 may have a rotationally symmetrical surface. Thereby, inspection during manufacturing can be simple. The shape of the outer diameter portion of the lens may be square or rectangular.

A description will now be given of conditions that may be satisfied by the optical system IO according to each example. The optical system IO according to each example includes an optical element made of glass or resin and disposed in an effective area that contributes to imaging. This optical element has a plane that contacts air, and satisfies the following inequality (2). This optical element may be a glass substrate GSB in each example but may be another optical element as long as inequality (2) is satisfied.

$$0.5 \leq θ \leq 20.0 \qquad ( 2 )$$

where θis an angle [°] of the plane relative to the optical axis OA in a section having the optical axis OA. The plane includes a lens surface, both surfaces of a flat plate, and a joint surface thereof.

Satisfying inequality (2) can tilt the object plane OB. Thereby, even when the optical system faces the object obliquely relative to the object rather than directly facing the optical system IO, the object plane OB can be made to coincide with the object plane. In a case where the value becomes lower than the lower limit of inequality (2), the effect of tilting the object plane OB becomes smaller. In a case where the value becomes higher than the upper limit of inequality (2), the tilt of the object plane OB becomes too large and manufacturing becomes difficult. Furthermore, a large space is required to dispose the tilted surface, and the size of the optical system IO increases.

The optical system IO according to each example may satisfy one or more of the following inequalities (3) to (10):

$$0.9 \leq Φ2i / Φ \leq 1.5 \qquad ( 3 )$$

$$0. \leq \vert Φ 1 o / Φ \vert \leq 0.4 \qquad ( 4 )$$

$$- 1.6 \leq Φ 1 i / Φ \leq - 0.2 \qquad ( 5 )$$

$$- 1.9 \leq Φ 1 i / Φ2 i \leq - 0.1 \qquad ( 6 )$$

$$0.1 \leq d 12 / f \leq 2. \qquad ( 7 )$$

$$35 < ω < 150 \qquad ( 8 )$$

$$0 < f \leq 10 \qquad ( 9 )$$

$$0.02 \leq f / id \leq 1. \qquad ( 10 )$$

Here, Φ is refractive power of the optical system IO. Φ1o is refractive power of the lens L11 formed on the object side of the substrate SB1. Φ1i is refractive power of the lens L12 formed on the image side of the substrate SB1. Φ2i is refractive power of the lens L2 formed on the image side of the substrate SB2. ω is an angle of view [°] in the direction connecting the center C of the light receiving surface and the optical axis OA. d12 is a distance on the optical axis from a surface on the image side of the lens L12 to a surface on the image side of the substrate SB2. f is a focal length of the optical system IO. id is a distance from the lens surface of the optical system IO closest to the object to the object to be recognized or detected.

The optical system IO according to each example has a reverse telephoto type configuration. This configuration can satisfactorily correct aberrations over a wide field of view range. This configuration is also effective for widening the angle of a coaxial system. In addition, an optical system IO where the optical axis OA and the center C of the light receiving surface are far apart is suitable because the one-sided angle of view on the opposite side across the center C of the light receiving surface and the optical axis OA are larger than that of a coaxial system where the one-sided angle of view is the same.

In a case where the value becomes lower than the lower limit of inequality (3), the incident angle on the light receiving surface becomes large, and crosstalk between pixels increases, etc. In a case where the value becomes higher than the upper limit of inequality (3), the positive and negative refractive powers constituting the reverse telephoto lens become too large, and the overall length will become too long.

By definition, the value never becomes lower than the lower limit of inequality (4). In a case where the value becomes higher than the upper limit of inequality (4), the refractive power of the lens L11, which is disposed closest to the object and is easily affected by external temperature changes, increases, and changes in image quality and focus position due to temperature changes become significant.

In a case where the value becomes lower than the lower limit of inequality (5), the incident angle on the light receiving surface becomes large. Further, the diameter of the lens L12 becomes large. In manufacturing the optical system IO according to each example, a surface distance (separation) is adjusted by interposing a spacer between the substrates SB1 and SB2. At this time, as the noneffective area of the lens L12 and the noneffective area of the lens formed on the object side of the substrate SB2 are wider, the area in which the spacer can be placed can be wider, and the accurate surface distance can be maintained. Thus, the diameter of the lens L12 may not be too large. In a case where the value becomes higher than the upper limit of inequality (5), the positive and negative refractive powers constituting the reverse telephoto type lens will become too large, and the overall length becomes too long.

In a case where the value becomes lower than the lower limit of inequality (6), the positive refractive power constituting the reverse telephoto type becomes too strong, the incident angle on the lens L2 becomes large, and it becomes difficult to correct off-axis aberrations. In a case where the value becomes higher than the upper limit of inequality (6), the negative refractive power constituting the reverse telephoto type lens becomes too strong, the diameter of the effective area of the lens L2 becomes larger than the surface of the lens L2, and the molding difficulty of the lens L2 increases.

In a case where the value becomes the lower limit of inequality (7), a distance between the lens having positive refractive power and the lens having negative refractive power in the reverse telephoto type reduces, the state approaches a single lens, and it becomes difficult to correct aberrations in a wide angle of view range, which would be achieved with the reverse telephoto type configuration. In a case where the value becomes higher than the upper limit of inequality (7), the light diverged by the lens on the substrate SB1 reaches the substrate SB2 after traveling a long optical path length. Therefore, a diameter of the effective area of the lens on the substrate SB2 increases, and the molding difficulty increases.

In a case where the value becomes lower than the lower limit of inequality (8), the angle of view reduces, and the object often falls out of the frame due to an error in the installation position of the image pickup apparatus or movement or shift of the object. This image pickup apparatus is unsuitable for a device such as HMDs and wearable devices. In a case where the value becomes higher than the upper limit of inequality (8), the angle of view becomes too wide and it becomes difficult to satisfactorily correct off-axis aberrations.

Since the optical system IO according to each example is created using the wafer level process, satisfying inequality (9) can increase the handling number per wafer, and manufacture many optical system IOs at one time. Since the optical system IO according to each example is an imaging lens for primary imaging and has positive refractive power, the value does not become lower than the lower limit of inequality (9). In a case where the value becomes higher than the upper limit of inequality (9), the size of the optical system IO increases.

In a case where the value becomes lower than the lower limit of inequality (10), the image magnification decreases and the effect of offsetting an image plane or introducing a tilted surface into the optical system IO reduces. In a case where the value becomes higher than the upper limit of inequality (10), a distance to the object becomes very short and it becomes difficult to illuminate the object. In a case where the object blurs or shifts, the image significantly moves, and it becomes difficult to image a desired area.

Inequalities (2) to (10) may be replaced with inequalities (2a) to (10a) below:

$$0.5 \leq θ \leq 18. \qquad ( 2 a )$$

$$0.9 \leq Φ2 i / Φ \leq 1.4 \qquad ( 3 a )$$

$$0. \leq \vert Φ 1 o / Φ \vert \leq 0.32 \qquad ( 4 a )$$

$$- 1.55 \leq Φ 1 i / Φ \leq - 0.25 \qquad ( 5 a )$$

$$- 1.7 \leq Φ 1 i / Φ2 i \leq - 0 \text{.15} \qquad ( 6 a )$$

$$0.2 \leq d 12 / f \leq 1.4 \qquad ( 7 a )$$

$$35 < ω < 100 \qquad ( 8 a )$$

$$0 < f \leq 7 \qquad ( 9 a )$$

$$0.025 \leq f / id \leq 0. 095 \qquad ( 10 a )$$

Inequalities (2) to (10) may be replaced with inequalities (2b) to (10b) below:

$$0.5 \leq θ \leq 13. \qquad ( 2 b )$$

$$0.93 \leq Φ2 i / Φ \leq 1.35 \qquad ( 3 b )$$

$$0. \leq \vert Φ 1 o / Φ \vert \leq 0.25 \qquad ( 4 b )$$

$$- 1.5 \leq Φ 1 i / Φ \leq - 0.3 \qquad ( 5 b )$$

$$- 1.5 \leq Φ 1 i / Φ2 i \leq - 0.2 \qquad ( 6 b )$$

$$0.3 \leq d 12 / f \leq 1.1 \qquad ( 7 b )$$

$$35 < ω < 70 \qquad ( 8 b )$$

$$0 < f \leq 3 \qquad ( 9 b )$$

$$0.035 \leq f / id \leq 0.085 \qquad ( 10 b )$$

A detailed description will be given of the optical system IO according to each example.

### EXAMPLE 1

As illustrated in FIG. 1, in this example, the object plane OB is tilted at 25 degrees relative to a plane orthogonal to the optical axis OA. That is, in a case where the object is a plane, a flat image plane can be obtained relative the object even when the optical system IO is disposed at an angle of 25 degrees.

The optical system IO according to this example is designed to focus on an object that is distant by 25 mm from a lens surface closest to the object.

FIG. 2 is an aberration diagram for a wavelength of 850 nm in an in-focus state at an object distance of 25 mm. The object distance is a distance from a lens surface on the object surface of the lens L11, and this is similarly applicable to other embodiments. Although the aberration diagram in FIG. 2 is measured for a wavelength of 850 nm, the optical system IO is also applicable to the visible region. In this case, the object distance becomes slightly shorter due to wavelength dispersion of the refractive index. In seeking an object distance of 25 mm, the distance between the light receiving surface and the substrate SB2 to be adjusted to be shorter.

In FIG. 11, the size of the effective area of the light receiving surface is 1.44 mm×1.92 mm, and the center C of the light receiving surface and the optical axis OA are separated by 0.36 mm. The optical system IO according to this example may be used as a coaxial system in combination with a light receiving element having an effective area size of 2.16 mm×1.96 mm, for example.

### EXAMPLE 2

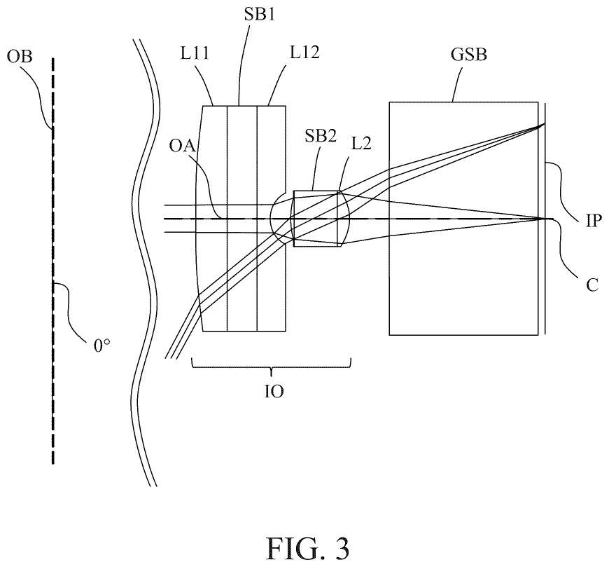

As illustrated in FIG. 3, in this example, the object plane OB is horizontal (parallel) to a plane orthogonal to the optical axis OA.

The optical system IO according to this example is designed to focus on an object that is distant by 25 mm from a lens surface closest to the object.

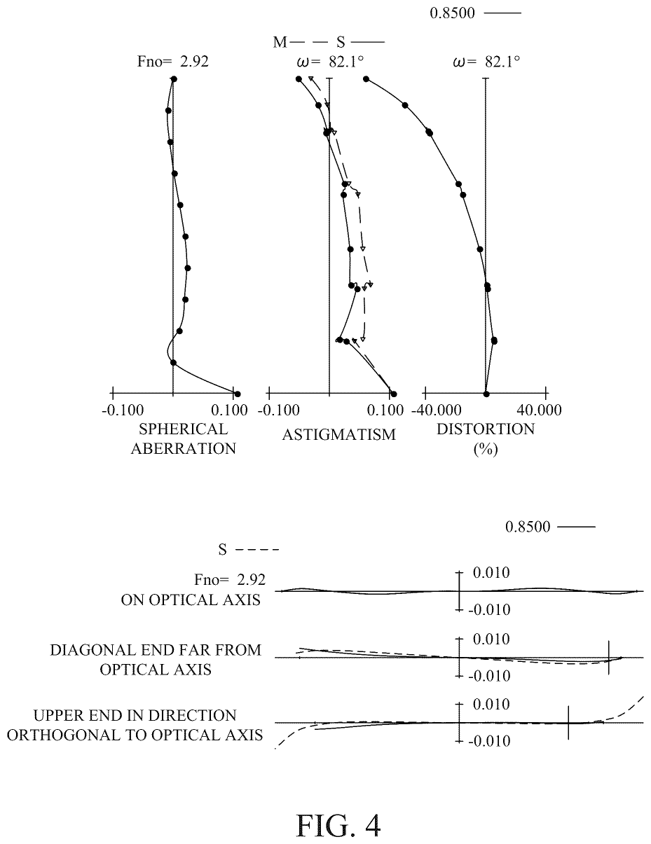

FIG. 4 is an aberration diagram for a wavelength of 850 nm in an in-focus state at an object distance of 25 mm.

In FIG. 12, the size of the effective area of the light receiving surface is 1.44 mm×1.96 mm, and the center C of the light receiving surface and the optical axis OA are separated by 0.72 mm. The optical system IO according to this example may be used as a coaxial system in combination with a light receiving element whose effective area is, for example, 2.88 mm×1.96 mm.

### EXAMPLE 3

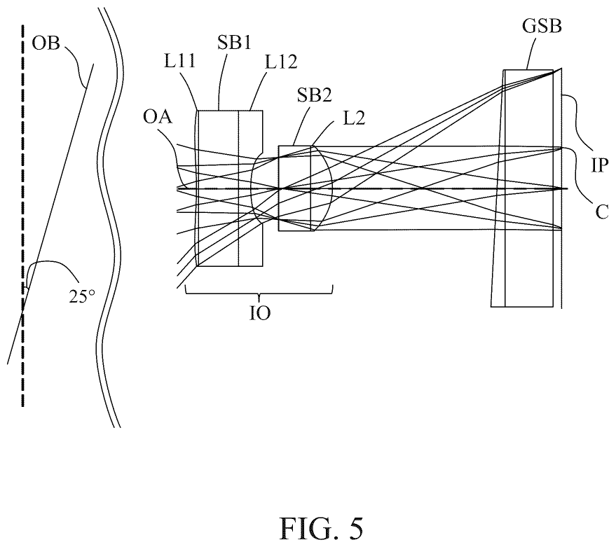

As illustrated in FIG. 5, in this example, the object plane OB is tilted at 25° relative to the plane orthogonal to the optical axis OA. The eighth surface counted from the object side is tilted by 10 degrees.

The optical system IO according to this example is designed to focus on an object that is distant by 25 mm from a lens surface closest to the object.

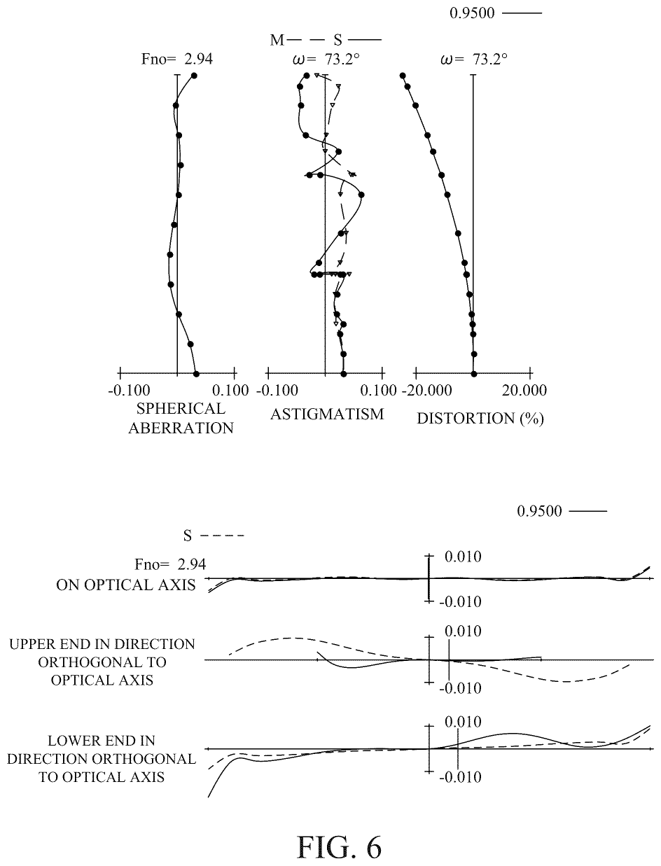

FIG. 6 is an aberration diagram for a wavelength of 950 nm in an in-focus state at an object distance of 25 mm in this example.

In FIG. 13, the size of the effective area of the light receiving surface is 1.41 mm×1.41 mm, and the center C of the light receiving surface and the optical axis are separated by 0.5 mm.

The optical system in the image pickup apparatus according to this example may be used as a coaxial system in combination with a light receiving element whose effective area size is, for example, 2.12 mm×2.12 mm.

### EXAMPLE 4

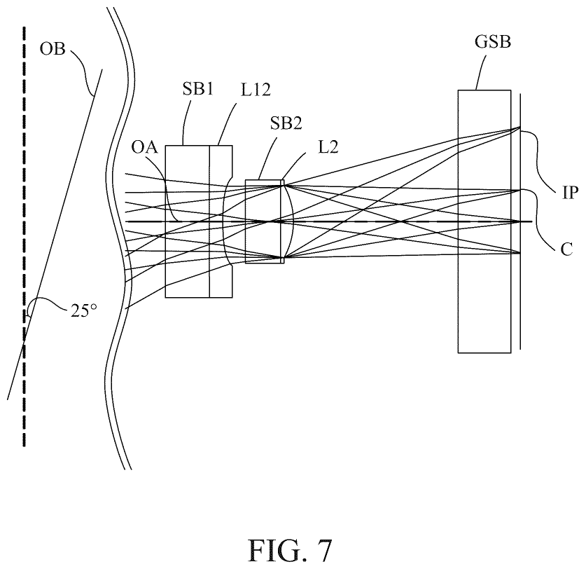

As illustrated in FIG. 7, in this example, the object plane OB is tilted at 45 degrees relative to the plane orthogonal to the optical axis OA.

The optical system IO according to this example is designed to focus on an object that is distant by 25 mm from a lens surface closest to the object.

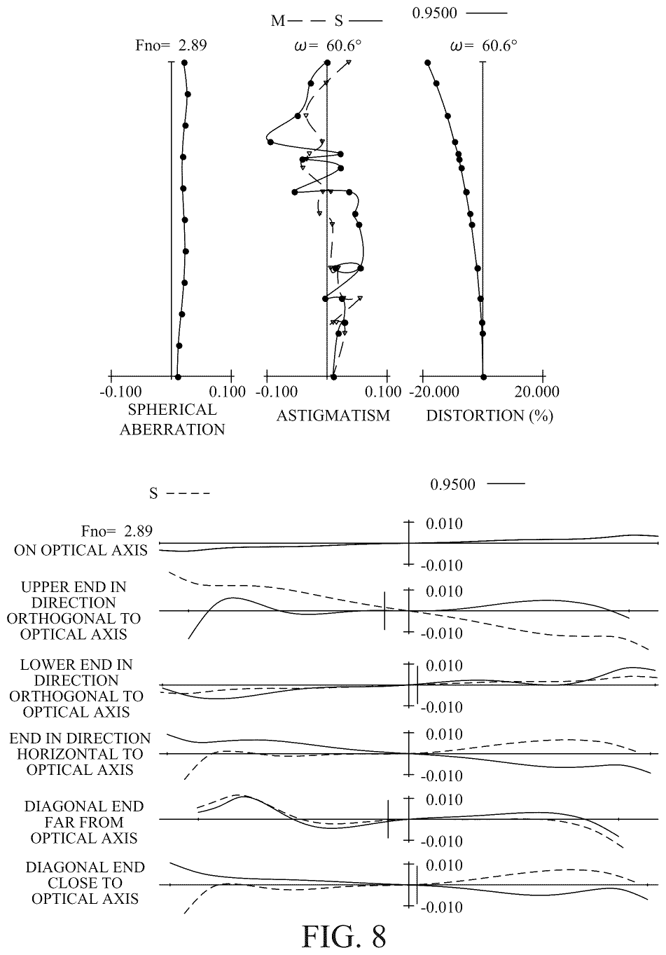

FIG. 8 is an aberration diagram for a wavelength of 950 nm in an in-focus state at an object distance of 25 mm in this example.

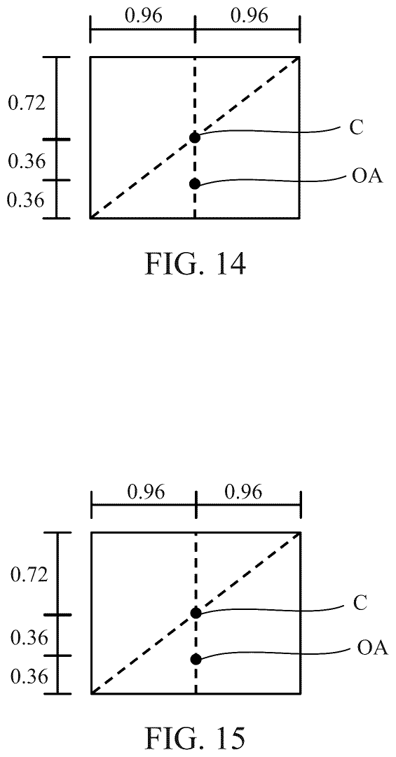

In FIG. 14, the size of the effective area of the light receiving surface is 1.44 mm×1.92 mm, and the center C of the light receiving element surface and the optical axis are separated by 0.72 mm. The optical system IO according to this example may be used as a coaxial system in combination with a light receiving element having an effective area size of 2.16 mm×1.96 mm, for example.

### EXAMPLE 5

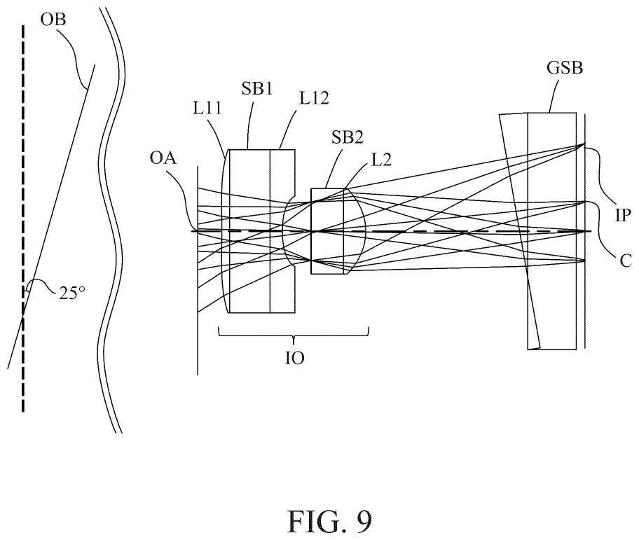

As illustrated in FIG. 9, in this example, the object plane OB is tilted at 25 degrees relative to the plane orthogonal to the optical axis OA. The eighth surface counted from the object side is tilted by 10 degrees.

The optical system IO according to this example is designed to focus on an object that is distant by 25 mm from the surface closest to the object.

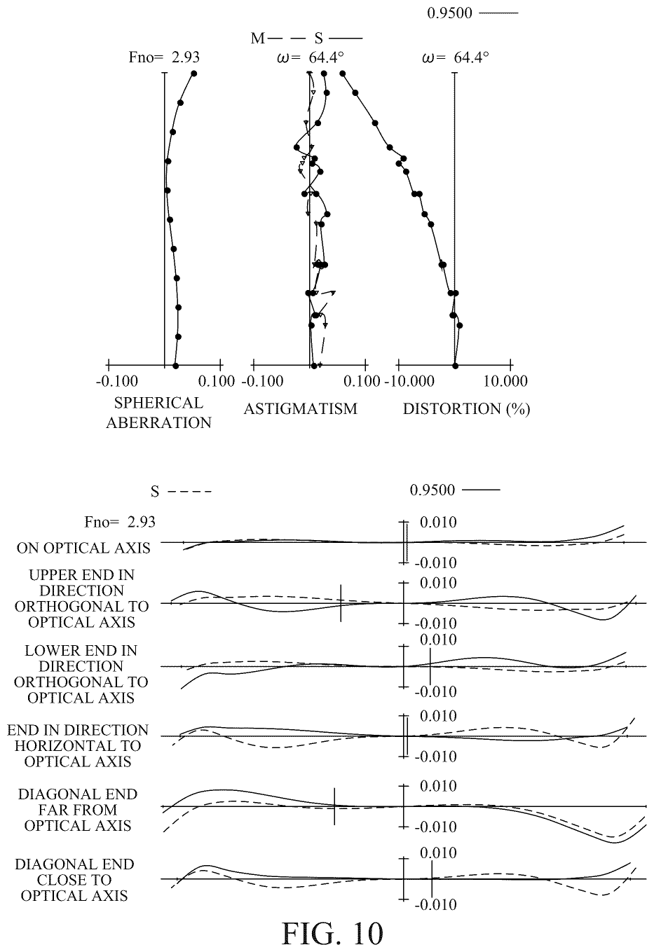

FIG. 10 is an aberration diagram for a wavelength of 950 nm in an in-focus state at an object distance of 25 mm in this example.

In FIG. 15, the size of the effective area of the light receiving surface is 1.44 mm×1.92 mm, and the center C of the light receiving surface and the optical axis OA are separated by 0.72 mm. The optical system IO according to this example may be used as a coaxial system in combination with a light receiving element having an effective area size of 2.16 mm×1.96 mm, for example.

Numerical values Examples 1 to 5 corresponding to Examples 1 to 5 will now be illustrated.

In surface data of each numerical example, r represents a radius of curvature of each optical surface, and d (mm) represents an on-axis distance (distance on the optical axis) between m-th and (m+1)-th surfaces, where m is a surface number counted from the light incident side. nd represents a refractive index of each optical member relative to the d-line, and vd represents an Abbe number of the optical member. The Abbe number vd of a certain material is expressed as follows:

vd=(Nd−1)/(NF−NC)

where Nd, NF, and NC are refractive indices for the d-line (587.6 nm), F-line (486.1 nm), and C-line (656.3 nm) in the Fraunhofer line.

In each numerical example, d, focal length (mm), F-number, and half angle of view (°) are all values in a case where the optical system IO according to each example is in an in-focus state on an object at infinity. “Back focus” is a distance on the optical axis from the final lens surface (lens surface closest to the image plane) to the paraxial image surface expressed in air equivalent length. The “overall lens length” is a length obtained by adding the back focus to the distance on the optical axis from the front most surface (lens surface closest to the object) of the optical system IO to the final surface.

An asterisk “*” attached to the right side of a surface number means that the optical surface is aspheric. The aspherical shape is expressed as follows:

$$x ( h ) = \frac{( \frac{{h}^{2}}{r} )}{1 + \sqrt{\{ 1 - ( 1 + k ) {( \frac{h}{r} )}^{2} \}}} + {A}_{4} {h}^{4} + {A}_{6} {h}^{6} + {A}_{8} {h}^{8} + {A}_{10} {h}^{10} + …$$

where X is a displacement amount from the surface vertex in the optical axis direction, h is a height from the optical axis in the direction perpendicular to the optical axis, R is a paraxial radius of curvature, K is a conical constant, and A4, A6, A8, and A10 are aspherical coefficients of each order. “e±XX” in each aspherical coefficient means “×10^{±XX}.”

NUMERICAL EXAMPLE 1
UNIT: mm
Surface Data

| Surface No. | r | d | nd | νd |
|---|---|---|---|---|
| 1* | −5.509 | 0.07 | 1.52000 | 50.3 |
| 2 | ∞ | 0.50 | 1.51680 | 64.2 |
| 3 | ∞ | 0.15 | 1.52000 | 50.3 |
| 4* | 1.244 | 0.37 | | |
| 5 | ∞ | 0.40 | 1.51680 | 64.2 |
| 6(Diaphragm) | ∞ | 0.29 | 1.52000 | 50.3 |
| 7* | −0.678 | 2.08 | | |
| 8 | ∞ | 0.60 | 1.51680 | 64.2 |
| 9 | ∞ | 0.02 | | |
| Image Plane | ∞ | | | |

### ASPHERIC DATA

### 1st Surface

K=2.35531e+01 A 4=2.50149c−01 A 6=−1.75859e−01 A 8=1.37283e−01 A10=−5.74951e−02 A12=1.64602e−02

### 4th Surface

K=−5.63858e+01 A 4=5.12936e+00 A 6=−4.96025e+01 A 8=4.80794e+02 A10=−2.37635e+03 A12=5.14895e+03

### 7th Surface

K=−2.17756e+00 A 4=−9.82178e−01 A 6=3.80210e+00 A 8=−1.89409e+01 A10=4.10014e+01 A12=−3.00511e+01

### Various Data

Focal Length: 1.69
Fno: 2.94
Half Angle of View (°): 40.54
Image Height: 1.45
Overall lens length: 4.48
BF 0.02

NUMERICAL EXAMPLE 2
UNIT: mm
Surface Data

| Surface No. | r | d | nd | νd |
|---|---|---|---|---|
| 1* | −7.241 | 0.47 | 1.52000 | 52.0 |
| 2 | ∞ | 0.45 | 1.51680 | 64.2 |
| 3 | ∞ | 0.20 | 1.52000 | 52.0 |
| 4* | 0.474 | 0.31 | | |
| 5* | 1.211 | 0.05 | 1.52000 | 52.0 |
| 6(Diaphragm) | ∞ | 0.65 | 1.51680 | 64.2 |
| 7 | ∞ | 0.19 | 1.52000 | 52.0 |
| 8* | −0.652 | 0.60 | | |
| 9 | ∞ | 2.25 | 1.51680 | 64.2 |
| 10 | ∞ | 0.15 | | |
| Image Plane | ∞ | | | |

### ASPHERIC DATA

### 1st Surface

K=−8.83070e+24 A 4=5.01855e−02 A 6=−2.87949e−02 A 8=9.54976e−03 A10=−1.88167e−03 A12=1.64587e−04

### 4th Surface

K=−1.58737e+00 A 4=3.26962e+00 A 6=−1.95957e+01 A 8=3.68431e+02 A10=−2.52129e+03 A12=7.56903e+03

### 5th Surface

K=0.00000e+00 A 4=3.06379e−01 A 6=−8.73788e−01 A 8=2.12766e+01 A10=−7.80674e+01

### 8th Surface

K=−8.02137e+00 A 4=−2.89928e+00 A 6=1.50497e+01 A 8=−5.84351e+01 A10=1.36717e+02 A12=−1.03590e+02

### Various Data

Focal Length: 1.26
Fno: 2.92
Half Angle of View (°): 54.16
Image Height: 1.74
Overall lens length: 5.33
BF 0.15

NUMERICAL EXAMPLE 3
UNIT: mm
Surface Data

| Surface No. | r | d | nd | νd |
|---|---|---|---|---|
| 1* | −4.316 | 0.03 | 1.52000 | 50.3 |
| 2 | ∞ | 0.50 | 1.51680 | 64.2 |
| 3 | ∞ | 0.15 | 1.52000 | 50.3 |
| 4* | 1.464 | 0.35 | | |
| 5 | ∞ | 0.40 | 1.51680 | 64.2 |
| 6(Diaphragm) | ∞ | 0.27 | 1.52000 | 50.3 |
| 7* | −0.697 | 2.06 | | |
| 8 | ∞ | 0.10 | 1.52000 | 50.3 |
| 9 | ∞ | 0.60 | 1.51680 | 64.2 |
| 10 | ∞ | 0.01 | | |
| Image Plane | ∞ | | | |

### ASPHERIC DATA

### 1st Surface

K=−2.10617e+01 A 4=1.74971e−01 A 6=−1.44608e−01 A 8=1.24732e−01 A10=−6.22057e−02 A12=8.82522e−03

### 4th Surface

K=−1.28664e+02 A 4=5.49992e+00 A 6=−5.93482e+01 A 8=5.28007e+02 A10=−2.36376e+03 A12=4.52864e+03

### 7th Surface

K=−1.54368e+00 A 4=−6.27126e−01 A 6=2.12523e+00 A 8=−1.08040e +01 A10=1.91688e+01 A12=−7.87762e+00

### Various Data

Focal Length: 1.76
Fno: 2.94
Half Angle of View (°): 40.38
Image Height: 1.50
Overall lens length: 4.48
BF 0.01

NUMERICAL EXAMPLE 4
UNIT: mm
Surface Data

| Surface No. | r | d | nd | νd |
|---|---|---|---|---|
| 1 | ∞ | 0.50 | 1.51680 | 64.2 |
| 2 | ∞ | 0.15 | 1.52000 | 50.3 |
| 3* | 2.814 | 0.26 | | |
| 4 | ∞ | 0.40 | 1.51680 | 64.2 |
| 5(Diaphragm) | ∞ | 0.15 | 1.52000 | 50.3 |
| 6* | −0.832 | 1.87 | | |
| 7 | ∞ | 0.60 | 1.51680 | 64.2 |
| 8 | ∞ | 0.00 | | |
| Image Plane | ∞ | | | |

### ASPHERIC DATA

### 3rd Surface

K=−3.69862e+01 A 4=1.03853e+00 A 6=−8.76771e+00 A 8=9.31896e+01 A10=−4.05184e+02 A12=7.02136e+02

### 6th Surface

K=−4.05569e+00 A 4=−9.48308e−01 A 6=2.86374e+00 A 8=−1.27932e+01 A10=2.26213e+01 A12=−9.63627e+00

### Various Data

Focal Length: 2.00
Fno: 2.89
Half Angle of View (°): 35.85
Image Height: 1.45
Overall lens length: 3.88
BF 0.00

### NUMERICAL EXAMPLE 5

### Unit mm

NUMERICAL EXAMPLE 5
UNIT: mm
Surface Data

| Surface No. | r | d | nd | νd |
|---|---|---|---|---|
| 1* | −11.062 | 0.10 | 1.52000 | 50.3 |
| 2 | ∞ | 0.50 | 1.51680 | 64.2 |
| 3 | ∞ | 0.15 | 1.52000 | 50.3 |
| 4* | 1.289 | 0.35 | | |
| 5 | ∞ | 0.40 | 1.51680 | 64.2 |
| 6(Diaphragm) | ∞ | 0.27 | 1.52000 | 50.3 |
| 7* | −0.681 | 1.90 | | |
| 8 | ∞ | 0.10 | 1.52000 | 50.3 |
| 9 | ∞ | 0.60 | 1.51680 | 64.2 |
| 10 | 8 | 0.00 | | |
| Image Plane | ∞ | | | |
| | ∞ | | | |

### ASPHERIC DATA

### 1st Surface

K=3.53565e+01 A 4=1.92148e−01 A 6=−1.30036e−01 A 8=6.08878e−02 A10=2.79929e−02 A12=−2.80722e−02

### 4th Surface

K=−5.52733e+01 A 4=4.73926e+00 A 6=−4.67300e+01 A 8=4.63193e+02 A10=−2.33351e+03 A12=5.09030e+03

### 7th Surface

K=−2.19034e+00 A 4=−9.14325e−01 A 6=2.77824e+00 A 8=−1.26744e+01 A10=2.32273e+01 A12=−1.08360e+01

### Various Data

Zoom Ratio 1.00
Focal Length: 1.71
Fno: 2.93
Half Angle of View (°): 40.24
Image Height: 1.45
Overall lens length: 4.38
BF 0.00

Table 1 summarizes various values according to each example.

| | EXAMPLE 1 | EXAMPLE 2 | EXAMPLE 3 | EXAMPLE 4 | EXAMPLE 5 |
|---|---|---|---|---|---|
| s/Rimmax | 0.3 | 0.6 | 0.501494 | 0.3 | 0.3 |
| θ(°) | — | — | 3 | — | 10 |
| Φ2i/Φ | 1.274 | 0.986 | 1.289 | 1.225 | 1.278 |
| abs(Φ1o/Φ) | 0.157 | 0.089 | 0.208 | — | 0.079 |
| Φ1i/Φ | −0.694 | −1.357 | −0.614 | −0.362 | −0.675 |
| Φ1i/Φ2i | −0.545 | −1.376 | −0.476 | −0.296 | −0.528 |
| d12/f | 0.457574 | 0.966221 | 0.424406 | 0.328992 | 0.442001 |
| ω(°) | 47.29378 | 61.91124 | 63.60281 | 39.04137 | 46.22662 |
| f | 1.689257 | 1.256852 | 1.763711 | 2.00005 | 1.707415 |
| f/id | 0.06757 | 0.050274 | 0.070548 | 0.080002 | 0.068297 |

### EXAMPLE 6

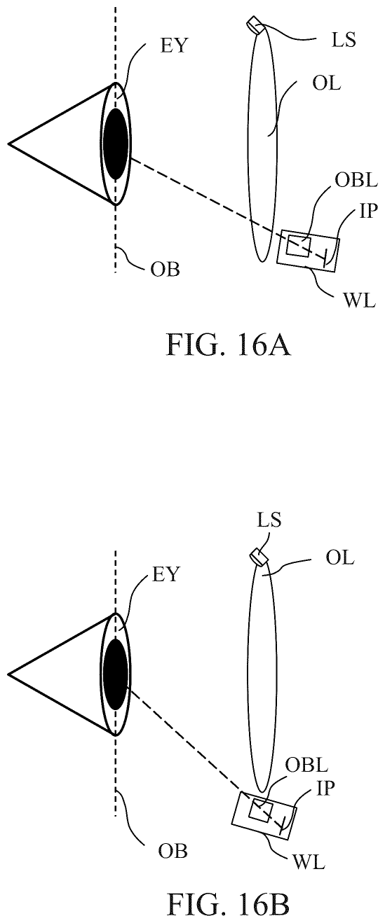

FIGS. 16A and 16B are schematic diagrams of main components of an eyepiece unit in an HMD as an example of an electronic apparatus having one of the image pickup apparatuses according to each example. The user views a virtual image of an image displayed on an unillustrated display unit through an eyepiece lens OL. User's eye EY is illuminated by a light source LS, and an image pickup apparatus WL acquires an image of the eye EY and an image of the light source LS reflected by the eye EY. At this time, the image pickup apparatus WL may acquire the image through the eyepiece lens OL as illustrated in FIG. 16A, or may acquire the image without using the eyepiece lens OL as illustrated in FIG. 16B. Here, the image pickup apparatus WL may be any of the image pickup apparatuses according to Examples 1 to 5. For example, in using any of the image pickup apparatuses according to Examples 1, 3 to 5, the image pickup apparatus WL may be disposed at an angle of 25 degrees relative to the eye EY. Even in a case where the object and the image pickup apparatus WL do not directly face each other in this way, high image quality can be obtained by using the optical systems IO according to Examples 1 to 5. Thereby, an image of the eye EY and an image of the light source LS reflected by the eye EY can be obtained with high definition. An unillustrated acquiring unit acquires information regarding the user using a signal from the image pickup apparatus WL. That is, the image pickup apparatus WL and the acquiring unit function as a detection system (sensing system) that performs highly accurate line of sight detection and biometric authentication such as iris authentication.

In this example, the light from the light source LS may be invisible light in order to prevent the user from feeling dazzled. More specifically, the emission wavelength of the light source LS may be approximately 700 nm or higher and 1100 nm or lower. In a case where the wavelength exceeds 1100 nm, the sensitivity of the light receiving element may decrease, and noise in the image pickup apparatus WL may increase.

This example has described an HMD as an example of an electronic apparatus having the image pickup apparatus according to each example, but the electronic apparatus may also be a viewfinder unit of a digital camera or a film-based camera.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an image pickup apparatus having a reduced size and including an optical system that has high optical performance even in a case where the optical system does not directly face an object.

This application claims priority to Japanese Patent Application No. 2023-112893, which was filed on Jul. 10, 2023, and which is hereby incorporated by reference herein in its entirety.

What is claimed is:

1. An image pickup apparatus comprising:
an optical system including a first substrate and a first optical element having refractive power disposed on the first substrate; and
a light receiving element having a light receiving surface on which an image is formed by the optical system,
wherein the following inequality is satisfied:
0.2≤s/Rimmax≤1.1
where s is a distance from an intersection of an optical axis of the optical system and the light receiving surface to a center of the light receiving surface, and Rimmax is a distance from a farthest position from the center of the light receiving surface to the center.

2. The image pickup apparatus according to claim 1, wherein the first optical element has negative refractive power and is disposed on a surface of an image side of the first substrate.

3. The image pickup apparatus according to claim 2, wherein the optical system includes:
a second substrate disposed adjacent to the image side of the first substrate; and
a second optical element having positive refractive power disposed on the image side of the second substrate.

4. The image pickup apparatus according to claim 3, wherein each of the first optical element and the second optical element has an aspherical surface.

5. The image pickup apparatus according to claim 3, wherein an aperture stop is formed on the second substrate.

6. The image pickup apparatus according to claim 3, wherein the optical system further includes a third optical element disposed on an object side of the first substrate.

7. The image pickup apparatus according to claim 6, wherein the third optical element includes an aspheric surface having positive refractive power at an end of an effective area.

8. The image pickup apparatus according to claim 1, further comprising an optical element having a plane that contacts air,
wherein the following inequality is satisfied:
$$0.5 \leq θ \leq 20.0$$
where θ is an angle [°] of the plane relative to the optical axis in a section having the optical axis.

9. The image pickup apparatus according to claim 3, wherein the following inequality is satisfied:
$$0.9 \leq Φ 2 i / Φ \leq 1.5$$
where Φ is refractive power of the optical system, and Φ2i is refractive power of the second optical element.

10. The image pickup apparatus according to claim 6, wherein the following inequality is satisfied:
$$0. \leq \vert Φ 1 o / Φ \vert \leq 0.4$$
where Φ is refractive power of the optical system, and Φ1o is refractive power of the third optical element.

11. The image pickup apparatus according to claim 3, wherein the following inequality is satisfied:
$$- 1.6 \leq Φ1 i / Φ \leq - 0.2$$
where Φ is refractive power of the optical system, and Φ1i is refractive power of the first optical element.

12. The image pickup apparatus according to claim 3, wherein the following inequality is satisfied:
$$- 1.9 \leq Φ 1 i / Φ2 i \leq - 0.1$$
where Pli is refractive power of the first optical element, and Φ2i is refractive power of the second optical element.

13. The image pickup apparatus according to claim 3, wherein the following inequality is satisfied:
$$0.1 \leq d 12 / f \leq 2.0$$
where d12 is a distance on the optical axis from a surface on the image side of the first optical element to a surface on the image side of the second substrate, and f is a focal length of the optical system.

14. The image pickup apparatus according to claim 1, wherein the following inequality is satisfied:
$$35 < ω < 150$$
where ω is an angle of view [°] in a direction connecting the center of the light receiving surface and the optical axis.

15. The image pickup apparatus according to claim 1, wherein the following inequality is satisfied:
$$0 < f \leq 10$$
where f [mm] is a focal length of the optical system.

16. The image pickup apparatus according to claim 1, wherein the following inequality is satisfied:
$$0.02 \leq f / id \leq 1.$$
where f is a focal length of the optical system, and id is a distance from a surface of the optical system closest to an object to the object.

17. The image pickup apparatus according to claim 1, further comprising a main optical system having an optical axis that coincides with the center of the light receiving surface on the light receiving surface,
wherein the optical axis of the optical system is tilted relative to the optical axis of the main optical system.

18. The image pickup apparatus according to claim 1, wherein on the light receiving surface, a center of an effective area that contributes to imaging does not coincide with the center of the light receiving surface.

19. An optical system comprising:
a first substrate;
a first optical element having refractive power disposed on the first substrate; and
an optical element having a plane that contacts air,
wherein the following inequality is satisfied:
$$0.5 \leq θ \leq 20.0$$
where θ is an angle [°] of the plane relative to an optical axis in a section having the optical axis.

20. A detection system comprising:
the image pickup apparatus according to claim 1; and
an acquiring unit configured to acquire information regarding an object using a signal from the image pickup apparatus.
